(19) United States
(12) Patent Application Publication
(10) Pub. No.: US 2005/0072728 A1
(43) Pub. Date: Apr. 7, 2005

(54) Simple faucet water-filtering device

(76) Inventor: Chin- Ching Chang, Taichung (TW)

Correspondence Address: BRUCE H. TROXELL;SUITE 1404, 5205 LEESBURG PIKE, FALLS CHURCH, VA, 22041, US

(21) Appl. No.: 10/679,330

(22) Filed: Oct. 7, 2003

(51) Int. Cl. B01D 24/00

(52) U.S. Cl. 210/446; 210/449; 210/460; 137/801

(57) ABSTRACT

A simple faucet water-filtering device including a main body and a connecting section. An upper end of the connecting section is adapted to connect with a spout of a faucet. A lower end of the connecting section is screwed with an upper cap of the main body. A lower end of the main body is formed with a water outlet. The main body has a casing defining a receiving space in which an energy cup is placed. An outer wall of the energy cup is formed with a spiral path, whereby a spiral water way is defined between the outer wall of the energy cup and inner wall of the receiving space. The water flows through the spiral water way and then flows out from the water outlet. The connecting section includes a faucet locking collar and an inner locking collar. The faucet locking collar has an inner conic opening at upper end. An upper end of the inner locking collar is formed with a conic section adapted to the inner conic opening of the faucet locking collar. An inner bushing is fitted in the inner locking collar.

### BACKGROUND OF THE INVENTION

The present invention is related to a simple faucet water-filtering device having simplified structure. The faucet water-filtering device can be quickly firmly fitted with a faucet for purifying tap water.

Taiwanese Utility Model Patent Publication No. 122700 discloses a faucet water filter. The water filter includes a main body which can smoothen the water flow and filter the water. The main body is funnel-shaped and has two openings at two ends. A fine metal mesh is disposed at the center of the main body. A rubber washer is fixed at the top opening for fitting with the faucet. By means of the fastening force of the rubber washer, the tap water is prevented from flowing back.

The fine metal mesh of the above faucet water filter can only filter off the larger particles entrained by the water, while failing to remove toxic materials contained in the water. Therefore, such water filter cannot meet the standard of safe water quality. Moreover, after a period of use of such water filter, some problems will take place and lead to inconvenience in use. For example, it often takes place that the rubber washer oldens and elastically fails to lose its fastening force. Accordingly, the water filter is apt to detach from the faucet.

Taiwanese Utility Model Patent Publication No. 129959 discloses a faucet water filter for solving the above problems. The water filter includes a main body, a top cap, a rubber fitting ring, a sleeve, a push rod, a locking tube and a press button. The main body has a substantially funnel-shaped connecting section on upper side and a hollow tube section downward extending from the connecting section. A screen tray is fitted on the bottom face of the hollow tube section. A washer and a ball valve are disposed on the top face. The tube body is formed with a cylindrical hole. A filter mesh is placed at the opening of the bottom face of the connecting section and covered by a circular cover board. Carbon granules are filled in the water filter. Two water-filtering cotton-made separating layers are previously overlaid on the bottom face and top face when filled. Taiwanese Utility Model Patent Publication No. 283995 discloses a multiple-bed mini-type water filter. The water filter includes a casing, a binding ring and a multiple-bed filter core. The multiple-bed filter core includes multiple filtering layers made of many varieties of filtering materials and multiple screens sandwiched between the filtering layers.

The above water filters enhance the water-purifying function of the traditional water filter and are able to remove some toxic materials. However, it is relatively complicated to process and assemble the above structure. Also, it is too troublesome to maintain and replace the components of such water filters. After a period of use, the rubber fitting ring and the binding ring will also elastically fail. A chain is additionally mounted at upper end of the rubber fitting ring or the binding ring to hang the water filter on the faucet near the tap for preventing the water filter from dropping. However, the tap water may flow back and spill.

### SUMMARY OF THE INVENTION

It is therefore a primary object of the present invention to provide a simple faucet water-filtering device having simplified structure. The faucet water-filtering device can effectively remove toxic materials and odors contained in the water. After a period of use, the filtering material can be easily replaced. Therefore, the faucet water-filtering device can be reused without wasting resource.

It is a further object of the present invention to provide the above faucet water-filtering device in which the connecting section can be more firmly connected with a faucet without easily detaching therefrom.

According to the above objects, the faucet water-filtering device includes a main body and a connecting section. An upper end of the connecting section is adapted to connect with a spout of a faucet. A lower end of the connecting section is screwed with an upper cap of the main body. A lower end of the main body is formed with a water outlet. The main body includes the upper cap, a casing, a flow-conducting screen cover, an energy cup and a water discharging connector. The casing defines therein a receiving space in which the energy cup is placed. An outer wall of the energy cup is formed with a spiral path, whereby a spiral water way is defined between the outer wall of the energy cup and inner wall of the receiving space. A water-filtering material is contained in the energy cup for acting on the water flowing through the energy cup. After filtered, the water flows through the spiral water way and then flows out from the water outlet of the bottom of the casing for serving a user.

The connecting section includes a faucet locking collar, an inner locking collar, an inner bushing and a two-way connector. The faucet locking collar defines a through hollow cavity. An upper end of the faucet locking collar is formed with an inner conic opening. A wall of the cavity is formed with an inner thread below the inner conic opening. The inner locking collar defines a cavity. An outer face of the inner locking collar is formed with an outer thread. An upper end of the inner locking collar is formed with a conic section adapted to the inner conic opening of the faucet locking collar. The inner bushing is placed in the cavity of the inner locking collar for enclosing the spout of the faucet.

The water-filtering material such as calcium sulfite contained in the energy cup acts on the water to remove the toxic materials and odors entrained by the water. By means of the spiral water way, the water will revolve and mix through a longer travel to speed the chemical reaction and prolong action time. Therefore, a better filtering effect is achieved.

The spout of the faucet is fitted in the inner conic opening of the top end of the faucet locking collar and inserted in the inner bushing fitted in the inner locking collar. When the faucet locking collar is tightly screwed with the inner locking collar, the conic section of the upper end of the inner locking collar is contracted. In cooperation with the inner conic opening of the top end of the faucet locking collar, the inner locking collar is tightly screwed with the faucet locking collar to firmly fix the water-filtering device with the inserted end of the faucet.

The present invention can be best understood through the following description and accompanying drawings wherein:

### BRIEF DESCRIPTION OF THE DRAWINGS

FIG. 1 is a perspective assembled view of the faucet water-filtering device of the present invention;

FIG. 2 is a perspective exploded view of the faucet water-filtering device of the present invention;

FIG. 3-1 is a sectional assembled view of the faucet water-filtering device of the present invention;

FIG. 3-2 is another sectional assembled view of the faucet water-filtering device of the present invention;

FIG. 3-3 is a perspective view of the flow-conducting screen cover of another embodiment of the faucet water-filtering device of the present invention;

FIG. 4 is a sectional view of the movable faucet of another embodiment of the faucet water-filtering device of the present invention; and

FIG. 5 is a sectional view showing the filtering procedure of the present invention.

### DETAILED DESCRIPTION OF THE PREFERRED EMBODIMENTS

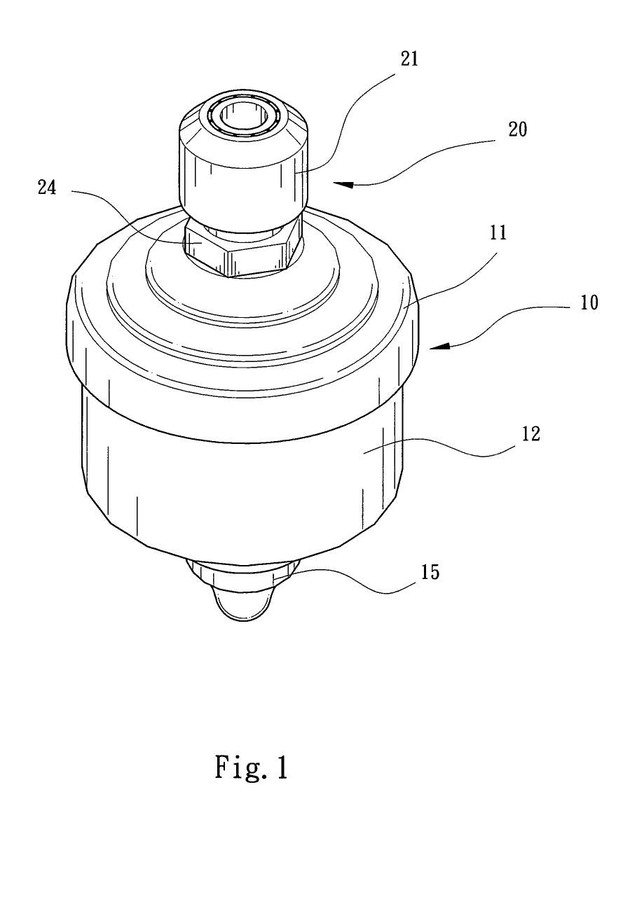

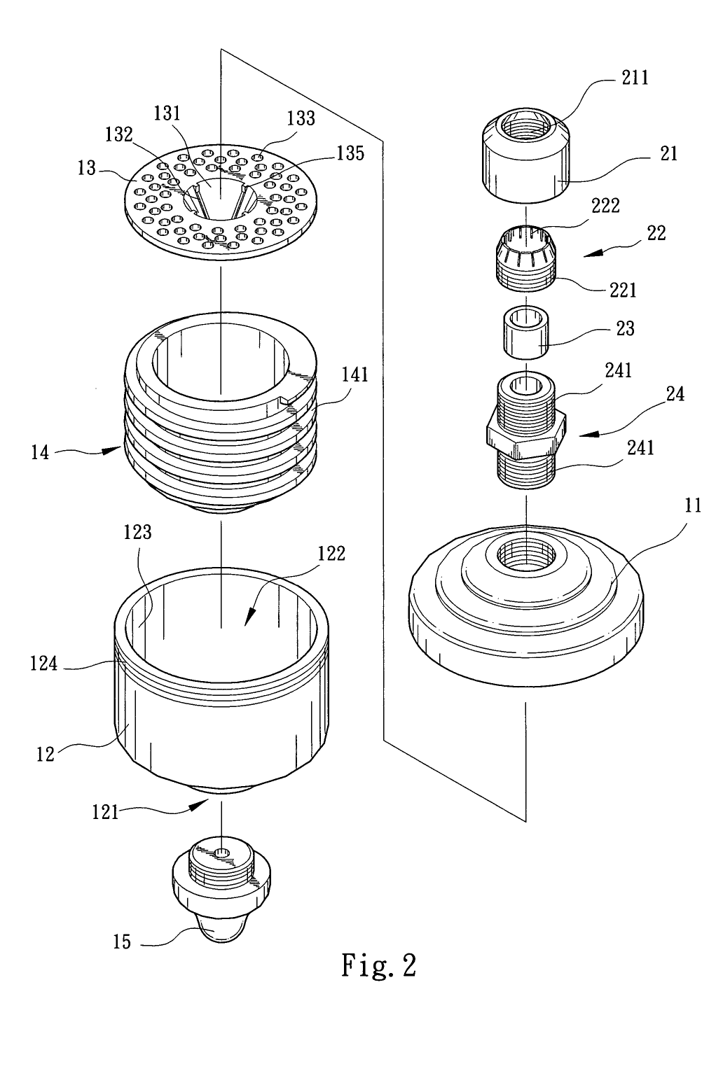

Please refer to FIGS. 1 and 2. The simple faucet water-filtering device of the present invention includes a main body 10 and a connecting section 20. An upper end of the connecting section 20 is connected with a spout of a faucet 40. A lower end of the connecting section 20 is screwed with an upper cap 11 of the main body 10. A lower end of the main body 10 is formed with a water outlet 121. The main body 10 is composed of the upper cap 11, a casing 12, a flow-conducting screen cover 13, an energy cup 14 and a water discharging connector 15. The casing 12 defines therein a receiving space 122 in which the energy cup 14 is placed. The outer wall of the energy cup 14 is formed with a spiral path 141, whereby a spiral water way 143 is defined between the outer wall of the energy cup 14 and the inner wall 123 of the receiving space 122. After flowing through the spiral water way 143, the water flows out from the water outlet 121 of the bottom of the casing 10.

The connecting section 20 is composed of a faucet locking collar 21, an inner locking collar 22, an inner bushing 23 and a two-way connector 24. The faucet locking collar 21 defines a through hollow cavity. An upper end of the faucet locking collar 21 is formed with an inner conic opening 211. The wall of the cavity is formed with an inner thread 212 below the inner conic opening 211. The inner locking collar 22 defines a cavity. The outer face of the inner locking collar 22 is formed with an outer thread 221. The upper end of the inner locking collar 22 is formed with a conic sect ion having at least one extensible split 222. The conic section of the inner locking collar 22 is adapted to the inner conic opening 211 of the faucet locking collar 21. The inner bushing 23 is placed in the cavity of the inner locking collar 22.

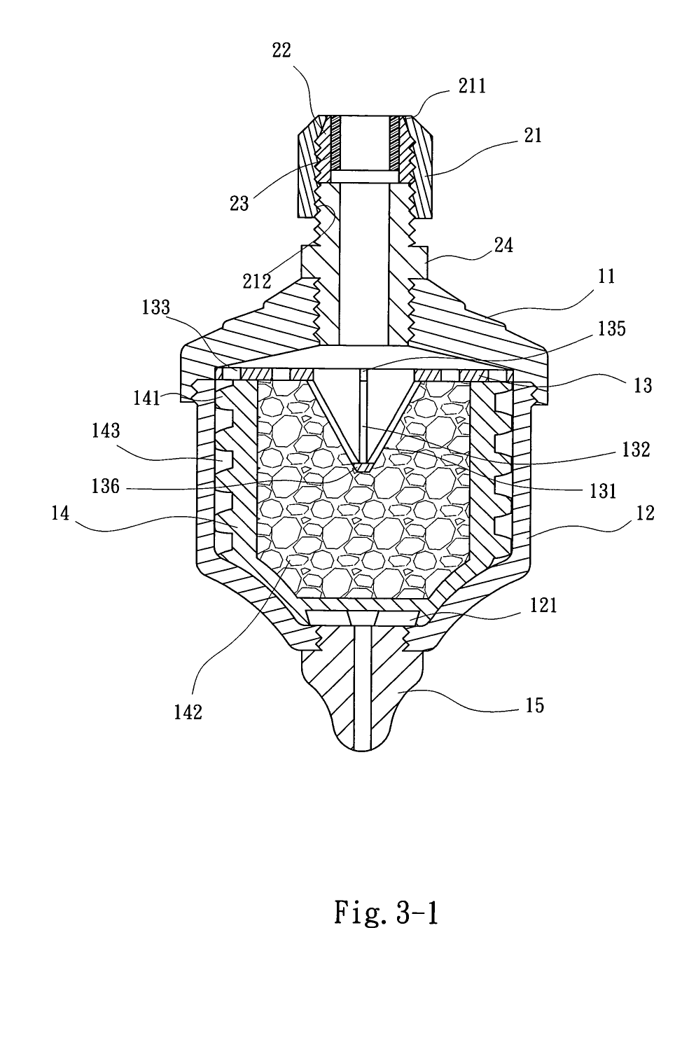

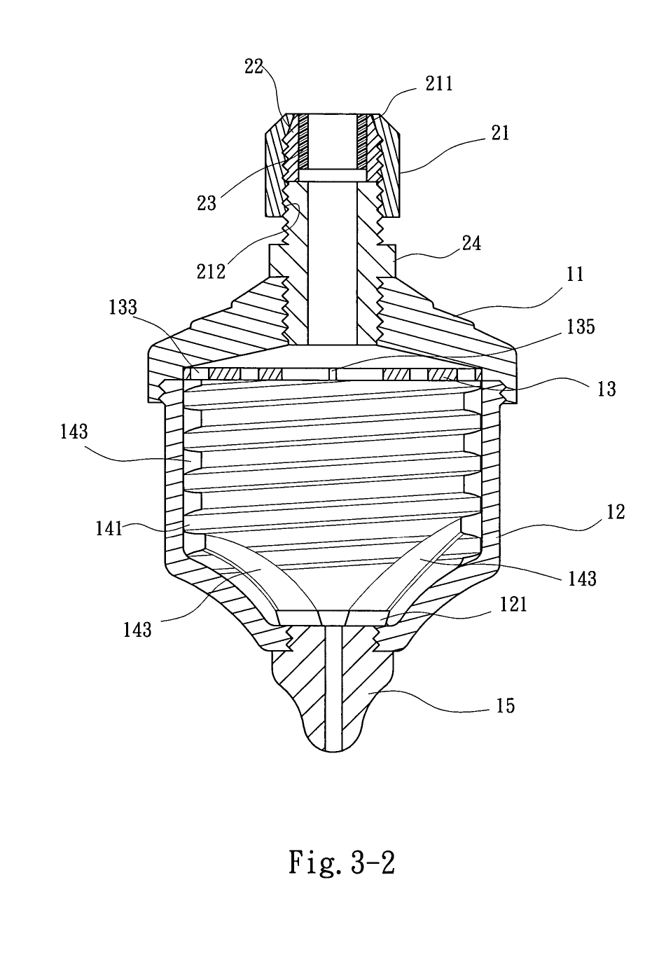

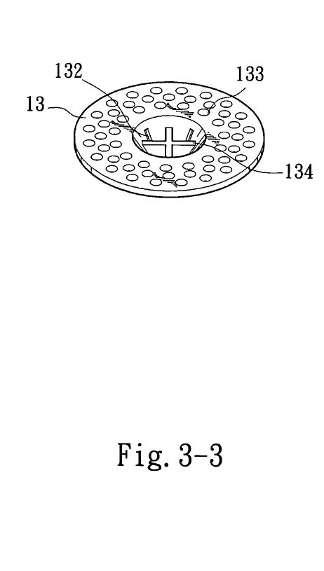

Referring to FIGS. 2, 3-1 and 3-2, the outer wall face of the upper opening of the casing 12 is formed with outer thread 124. The energy cup 14 is disposed in the receiving space 122 of the casing 12. A water-filtering material 142 (such as calcium sulfite) is contained in the energy cup 14. The flow-conducting screen cover 13 is tightly disposed at the upper opening of the energy cup 14. The upper cap 11 is screwed on upper end of the casing 12 to fix the flow-conducting screen cover 13 and the energy cup 14 in the casing 12. The water discharging connector 15 is connected with the water outlet 121 of lower end of the casing 12, whereby the treated water can concentrate and flow out from the water discharging connector 15. The center of the flow-conducting screen cover 13 is formed with a funnel-shaped conducting section 131. The circumference of the flow-conducting screen cover 13 is formed with multiple orifices 133. The conducting section 131 is formed with multiple slits 132. Reinforcing ribs 134, 135 and adjoining face 136 are formed adjacent to the slits 132 for reinforcing the conducting section 131. The conducting section 131 serves to conduct the water to flow through the slits 132 into the energy cup 14. After the water and the filtering material 142 in the energy cup 14 interact on each other, the water then upward spills out from the orifices 133 of the circumference of the flow-conducting screen cover 13 into the space between the upper cap 11 and the flow-conducting screen cover 13. Then the water downward flows into the spiral water way 143 defined by the spiral path 141. When the water passes through the water-filtering material such as calcium sulfite contained in the energy cup 14, the calcium sulfite can absorb and remove many varieties of toxic materials entrained by the water. The above water-filtering device has simplified structure and it is easy to maintain and replace the components of the water-filtering device.

The upper and lower ends of the hollow two-way connector 24 are formed with outer threads 241. The connecting section 20 is connected with the main body 10 in such a manner that the outer thread 241 of the upper end of the two-way connector 24 is screwed in the inner thread 212 of the lower end of the faucet locking collar 21. The outer thread 241 of the lower end of the two-way connector 24 is screwed in the inner thread of the top end of the upper cap 11 of the main body 10. When the top end of the connecting section 20 is fitted on the spout of the faucet 40, the spout is fitted in the inner conic opening 211 of the top end of the faucet locking collar 21 and inserted in the inner bushing 23 fitted in the inner locking collar 22. When the faucet locking collar 21 is tightly screwed with the inner locking collar 22, the conic section of the upper end of the inner locking collar 22 is contracted. The extensible splits 222 of the conic section make it easier to contract the conic section. In cooperation with the inner conic opening 211 of the top end of the faucet locking collar 21, the tighter the inner locking collar 22 is screwed with the faucet locking collar 21, the tighter the inserted end of the faucet 40 is fastened.

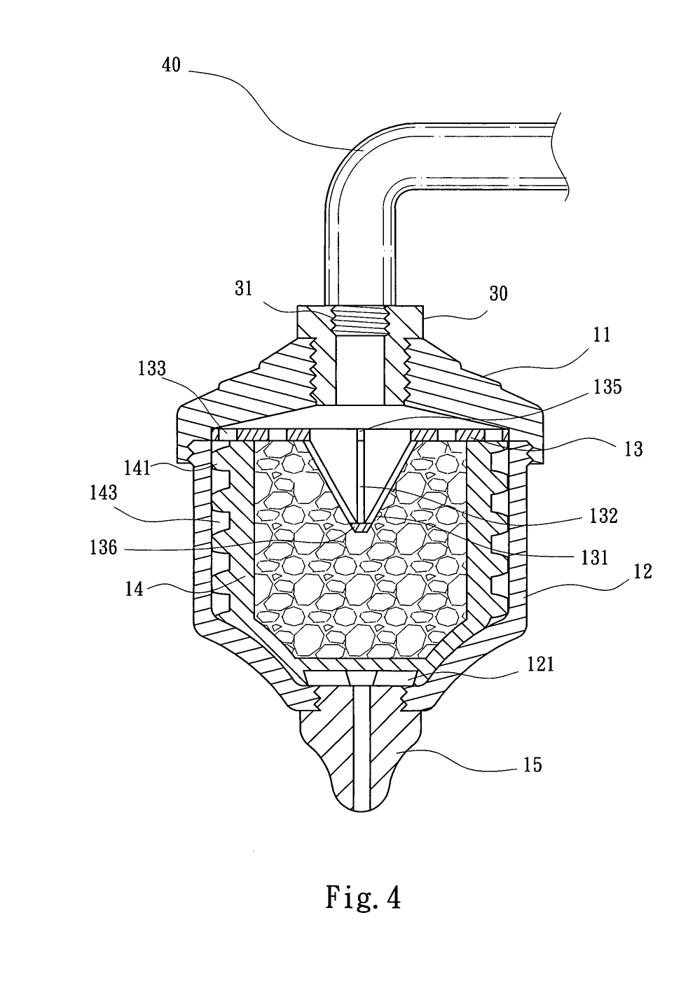

FIG. 4 shows another embodiment of the present invention, in which the connecting section 20 is replaced with a movable faucet 30. The upper end of the movable faucet 30 is formed with inner thread 31 or outer thread (not shown). This embodiment is applicable to a faucet having sprinkling head. The sprinkling head can be detached from the faucet. Instead, the upper end of the movable faucet 30 is screwed on the faucet 40.

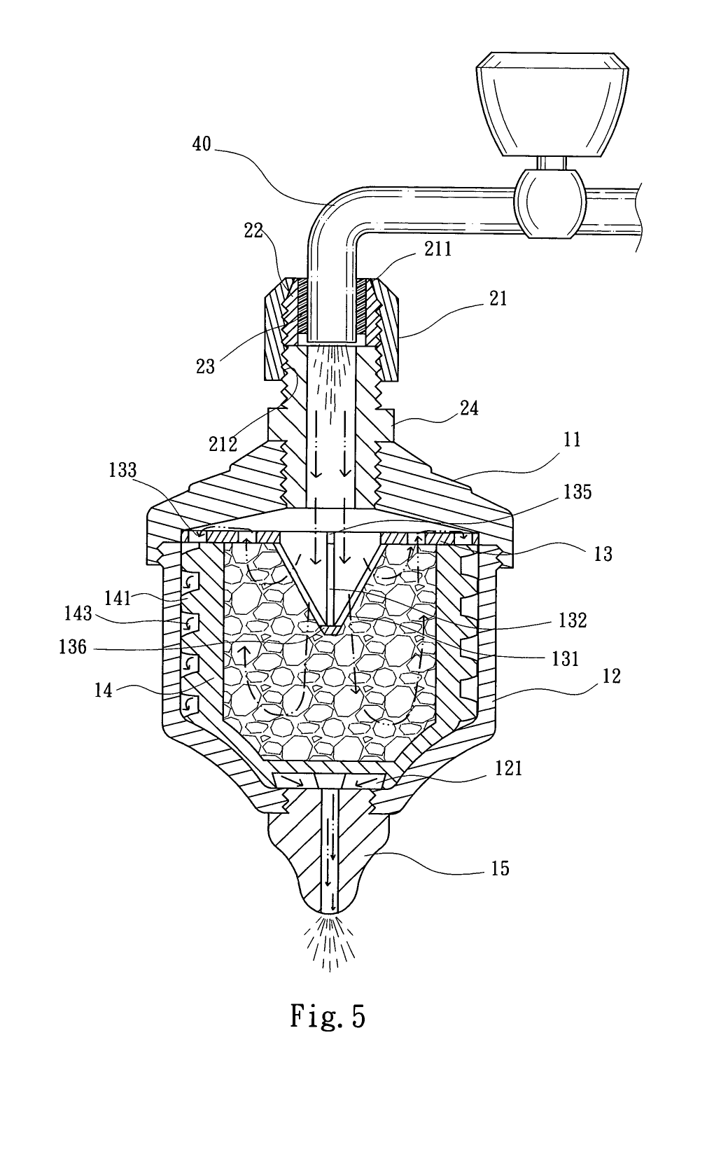

FIG. 5 shows the treatment of the water according to the present invention. When the faucet 40 is turned on and the tap water flows into the water-filtering device of the present invention, the connecting section 20 conducts the water into the flow-conducting screen cover 13 of the main body 10. The tap water flows through the conducting section 131 into the energy cup 14. The specific water-filtering material 142 acts on the water to remove the toxic material entrained by the water, especially the chlorine component remaining in the tap water. Due to water pressure, the treated water further spills out from the orifices 133 of the circumference of the flow-conducting screen cover 13 into the spiral water way 143. Then the water flows out from the water discharging connector 15 screwed with the bottom of the casing 12.

The above embodiments are only used to illustrate the present invention, not intended to limit the scope thereof. Many modifications of the above embodiments can be made without departing from the spirit of the present invention.

1. A simple faucet water-filtering device comprising a main body and a connecting section, an upper end of the connecting section being adapted to connect with a spout of a faucet, a lower end of the connecting section being screwed with an upper cap of the main body, a lower end of the main body being formed with a water outlet, the faucet water-filtering device being characterized in that the main body including the upper cap, a casing, a flow-conducting screen cover, an energy cup and a water discharging connector, the casing defining therein a receiving space in which the energy cup is placed, an outer wall of the energy cup being formed with a spiral path, whereby a spiral water way is defined between the outer wall of the energy cup and inner wall of the receiving space, a water-filtering material being contained in the energy cup for acting on the water flowing through the energy cup, whereby after filtered, the water flows through the spiral water way and then flows out from the water outlet of the bottom of the casing for serving a user.

2. The simple faucet water-filtering device as claimed in claim 1, wherein the connecting section includes a faucet locking collar, an inner locking collar, an inner bushing and a two-way connector, the faucet locking collar defining a through hollow cavity, an upper end of the faucet locking collar being formed with an inner conic opening, a wall of the cavity being formed with an inner thread below the inner conic opening, the inner locking collar defining a cavity, an outer face of the inner locking collar being formed with an outer thread, an upper end of the inner locking collar being formed with a conic section adapted to the inner conic opening of the faucet locking collar, the inner bushing being placed in the cavity of the inner locking collar.

3. The simple faucet water-filtering device as claimed in claim 2, wherein the conic section of the inner locking collar has extensible splits.

4. The simple faucet water-filtering device as claimed in claim 2, wherein upper end of the two-way connector is screwed in the inner thread of the lower end of the faucet locking collar, while lower end of the two-way connector is screwed in the inner thread of the upper cap.

5. The simple faucet water-filtering device as claimed in claim 1, wherein the connecting section is a movable faucet, upper end of the movable faucet being formed with inner thread or outer thread for screwing on a faucet.

6. The simple faucet water-filtering device as claimed in claim 1, wherein outer wall face of the upper end of the casing is formed with outer thread, the upper cap being screwed on the outer thread of the upper end of the casing to fix the flow-conducting screen cover and the energy cup in the casing.

7. The simple faucet water-filtering device as claimed in claim 2, wherein outer wall face of the upper end of the casing is formed with outer thread, the upper cap being screwed on the outer thread of the upper end of the casing to fix the flow-conducting screen cover and the energy cup in the casing.

8. The simple faucet water-filtering device as claimed in claim 1, wherein the water discharging connector is screwed with the water outlet of the bottom of the casing.

9. The simple faucet water-filtering device as claimed in claim 2, wherein the water discharging connector is screwed with the water outlet of the bottom of the casing.

10. The simple faucet water-filtering device as claimed in claim 1, wherein the flow-conducting screen cover is overlaid on the upper opening of the energy cup, a center of the flow-conducting screen cover being formed with a funnel-shaped conducting section, a circumference of the flow-conducting screen cover being formed with multiple orifices.

11. The simple faucet water-filtering device as claimed in claim 2, wherein the flow-conducting screen cover is overlaid on the upper opening of the energy cup, a center of the flow-conducting screen cover being formed with a funnel-shaped conducting section, a circumference of the flow-conducting screen cover being formed with multiple orifices.

12. The simple faucet water-filtering device as claimed in claim 6, wherein the flow-conducting screen cover is overlaid on the upper opening of the energy cup, a center of the flow-conducting screen cover being formed with a funnel-shaped conducting section, a circumference of the flow-conducting screen cover being formed with multiple orifices.

13. The simple faucet water-filtering device as claimed in claim 7, wherein the flow-conducting screen cover is overlaid on the upper opening of the energy cup, a center of the flow-conducting screen cover being formed with a funnel-shaped conducting section, a circumference of the flow-conducting screen cover being formed with multiple orifices.

14. The simple faucet water-filtering device as claimed in claim 10, wherein the conducting section of the flow-conducting screen cover is formed with slits.

15. The simple faucet water-filtering device as claimed in claim 14, wherein the conducting section is formed with reinforcing ribs and adjoining face adjacent to the slits of the conducting section for reinforcing the conducting section.

16. The simple faucet water-filtering device as claimed in claim 11, wherein the conducting section of the flow-conducting screen cover is formed with slits.

17. The simple faucet water-filtering device as claimed in claim 12, wherein the conducting section of the flow-conducting screen cover is formed with slits.

18. The simple faucet water-filtering device as claimed in claim 13, wherein the conducting section of the flow-conducting screen cover is formed with slits.

19. The simple faucet water-filtering device as claimed in claim 1, wherein the water-filtering material is calcium sulfite.

20. The simple faucet water-filtering device as claimed in claim 2, wherein the water-filtering material is calcium sulfite.
